(19) United States
(12) Patent Application Publication
(10) Pub. No.: US 2017/0106831 A1
(43) Pub. Date: Apr. 20, 2017

(54) SEAT BELT CUTTER

(71) Applicant: Mary Garabedian, Glendale, CA (US)

(72) Inventor: Mary Garabedian, Glendale, CA (US)

(21) Appl. No.: 14/885,738

(22) Filed: Oct. 16, 2015

(51) Int. Cl. B60R 22/32; B26B 27/00

(52) U.S. Cl. CPC B60R 22/32; B26B 27/00; B60R 2022/328

(57) ABSTRACT

A seat belt cutting device comprising a clip portion having a first half portion and a second half portion attached together at a first end by means of a hinge and at a second end by means of a clip and a blade portion extending along the mid section of the first half portion of the clip portion. The clip portion has a cavity with slotted parallel openings on either side to direct the seat belt there through. The blade portion includes a movable blade and a handle attached to the blade to pull the blade. The seat belt cutting device is configured to be mounted on a seat belt of a vehicle for cutting the seat belt following an accident.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE DISCLOSURE

This embodiment relates to automotive safety tools, and more particularly to an automotive safety tool for cutting a seat belt of a vehicle following an accident or some other serious vehicular mishap.

### DISCUSSION OF RELATED ART

The use of seatbelts by drivers and passengers in automobiles can avoid or cut down the seriousness of injuries incurred in automobile accidents. In many areas, the use of automobile seatbelts has become mandatory. However, sometimes the use of seatbelts may be a fear on the part of the wearer that the seat belt might act as a trap preventing escape from the vehicle after an accident, in case of fire or the like. Contributing to this fear is the fact that often the release mechanisms of seatbelts and restraint harnesses are complicated and inconvenient to reach and often occupants may get stuck and thus it impossible to be released, so in many cases cutting the belt is the only way out.

Cutting devices, mounted somewhere reachably in the interior of the vehicle, have been used so that the belt can be cut in an emergency. However, such cutting devices are often unreachable after an accident because, as a result of the accident, the occupant strapped into his seat cannot reach the cutting device or the cutting device has been displaced by the accident and is no longer in a reachable place. The use of such a cutting device under high-stress accident conditions however is somewhat problematic since such a cutting device has to be used carefully to avoid injuries to the occupant. The resulting stress and chaos of an accident may lead the occupant to not fully carry out the required care of using such cutting devices, and consequently the occupant may inadvertently injury themselves while attempting to extricate themselves or to operate cutting devices.

In some existing seat belt cutting devices, a housing to be mounted on a safety belt is provided having an operating element so as to be movable across the safety belt. The housing has an at least partially U-shaped portion having legs extending essentially parallel to the plane of the belt so as to form a belt-receiving gap wherein a cutting blade with a cutting edge is so mounted that the cutting edge of the blade extends through the gap at an angle to the plane of the belt and is exposed only within the gap of the operating element so that the safety belt is guided within the gap onto the cutting edge so as to be severed if, after an accident, the operating element is moved across the safety belt. However, the device is complicated in design, difficult to open and clip on a seat belt.

Some other existing seat belt cutting devices provide an accessory that can be actuated in emergency situations to sever the belt and allow the belt user to be freed from the belt. This accessory has a pair of parallel blades one of which may be pulled along the other to sever the belt scissor-fashion when a force exceeding a predetermined minimum force is exerted on the blade pull. The movable blade may be spring-loaded so that simple actuation of a pushbutton or withdrawal of an operating pin allows the springs to push the movable blade across the fixed blade and sever the belt. Such an accessory is mounted on the seat belt in the middle of the chest of the user to make it readily accessible to the user or a rescuer in an emergency situation. However, it will be difficult to actuate the pushbutton or withdraw the operating pin in case of an emergency.

Another existing seat belt cutting device provides an apparatus wherein a unitary housing includes a “V” shaped slot defining an upper and lower planar wall, with an acute angle there between. The lower planar wall includes a blade member arranged essentially coextensively therewith, with the slot arranged for receiving a seat belt for emergency severing thereof. A plurality of hook and loop fasteners mounted to a first side wall of the housing is selectively and removably securable to a like plurality of hook and loop fasteners mounted to an associated seat belt. However, such devices cannot be fastened to a seat belt.

Therefore, there is a need for a seat belt cutting device that is mounted on the seat belt. Such a needed seat belt cutting device would provide safety and easy access. Further, the seat belt cutting device would be brightly-colored and always be readily accessible on the webbing when needed. Finally, the holder would be lightweight, reliable, affordable, compact, and user-friendly. The present embodiment accomplishes these objectives.

### SUMMARY OF THE DISCLOSURE

The present embodiment is a seat belt cutting device installed as a clip-on in a vehicle seat belt, for cutting the seat belt following an accident or some other serious vehicular mishap. The seat belt cutting device comprises a clip portion having a first half portion and a second half portion. The first half portion and the second half portion are attached together at a first end by means of a hinge and at a second end by means of a clip. The first half portion of the clip portion includes a blade portion extending along the mid section of the first half portion. The blade portion includes a movable blade and a handle attached to the blade to pull the blade along the midsection of the clip portion. Additionally, the movable blade may be spring-loaded and would contain a clip lock and snaps on one end.

The clip portion has a cavity with slotted parallel openings on either side to direct the seat belt there through. The clip may be released to open and close the clip portion around the seat belt for a tight fit. The button portion is raised higher to keep the belt firm. The movable blade has a protected serrated cutting edge disposed at one edge of the seat belt and inclined thereto for slitting the seat belt from side to side.

The seat belt cutting device can be any color for quickly and easily being seen and used when needed. The seat belt cutting device provides safety, easy access, and has a user-friendly design. Instead of being unable to escape a seat following a wreck or some other emergency, the seat belt cutting device could slice the seat belt in half to quickly exit the interior. The seat belt cutting device would also be lightweight, reliable, affordable, compact, and user-friendly.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a top view of a seat belt cutting device in accordance with a preferred embodiment of the present invention;

FIG. 2 is a side view of the seat belt cutting device in accordance with the preferred embodiment of the present invention;

FIG. 3 is a side view of the seat belt cutting device opened in accordance with the preferred embodiment of the present invention;

FIG. 4 is a back view of the seat belt cutting device in accordance with the preferred embodiment of the present invention;

FIG. 5 is a sectional view of the seat belt cutting device in accordance with the preferred embodiment of the present invention; and

FIG. 6 illustrates the seat belt cutting device attached to a seat belt.

### DETAILED DESCRIPTION OF THE PREFERRED EMBODIMENT

The following describes example embodiments in which the present invention may be practiced. This invention, however, may be embodied in many different ways, and the description provided herein should not be construed as limiting in any way. Among other things, the following invention may be embodied as methods or devices. The following detailed descriptions should not be taken in a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

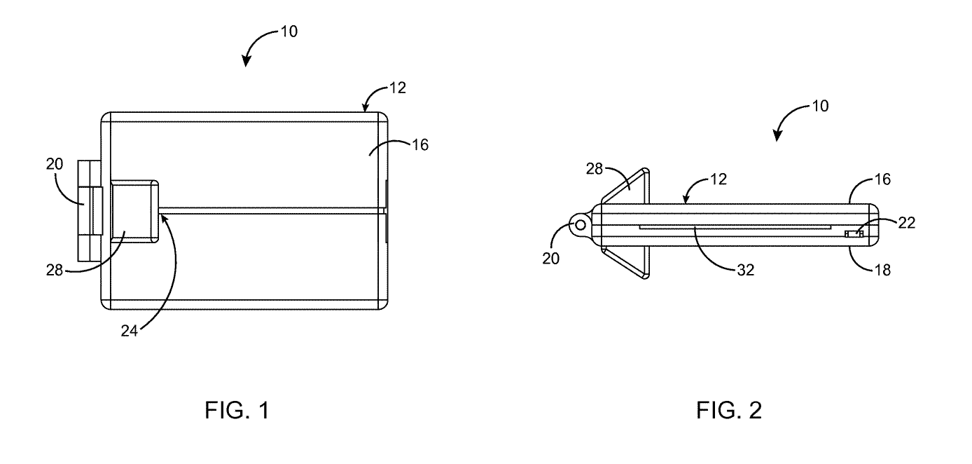

Referring to FIGS. 1 and 2, top and side views of a seat belt cutting device 10 in accordance with a preferred embodiment of the present invention are respectively illustrated. The seat belt cutting device 10 essentially comprises a clip portion 12 selectively securable to an associated flexible seat belt 14 (See FIG. 6). The clip portion 12 is made of hard plastic and measures approximately 2 inches tall and 4 inches wide. The clip portion 12 has a first half portion 16 and a second half portion 18. The first half portion 16 and the second half portion 18 are attached together at a first end by means of a hinge 20 and at a second end by means of a clip 22. The first half portion 16 of the clip portion 12 includes a blade portion 24 extending along the mid section of the first half portion 16.

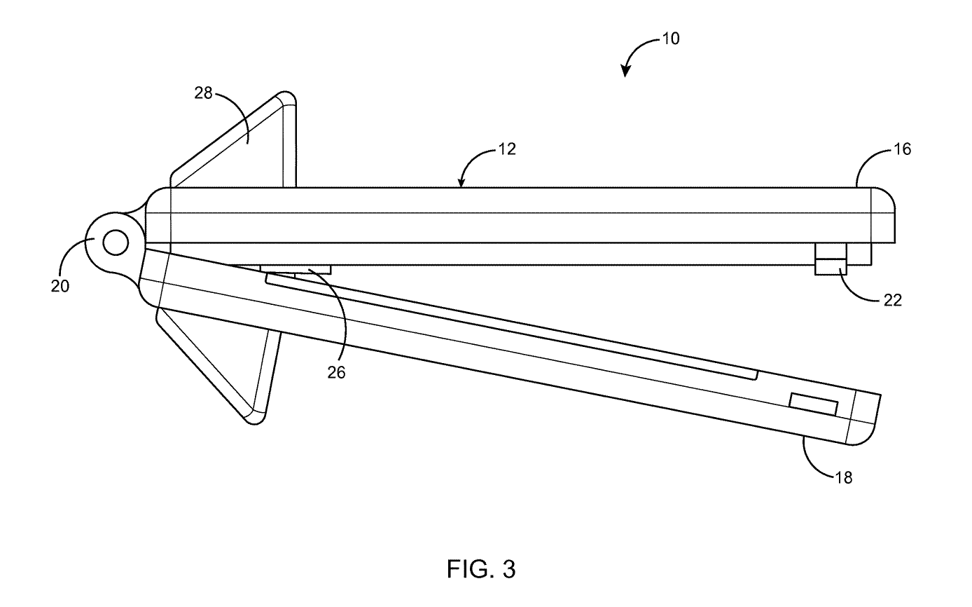

FIG. 3 is a side view of the seat belt cutting device 10 in an open condition in accordance with the preferred embodiment of the present invention. In one embodiment, the clip 22 may be released to open and close the clip portion 12 around the seat belt 14 (See FIG. 6) for a tight fit. The blade portion 24 includes a movable blade 26 and a handle 28 attached to the movable blade 26 to pull the blade 26 along the midsection of the clip portion 12. Additionally, the movable blade 26 may be spring-loaded and would contain a lock snap (not shown) on one end.

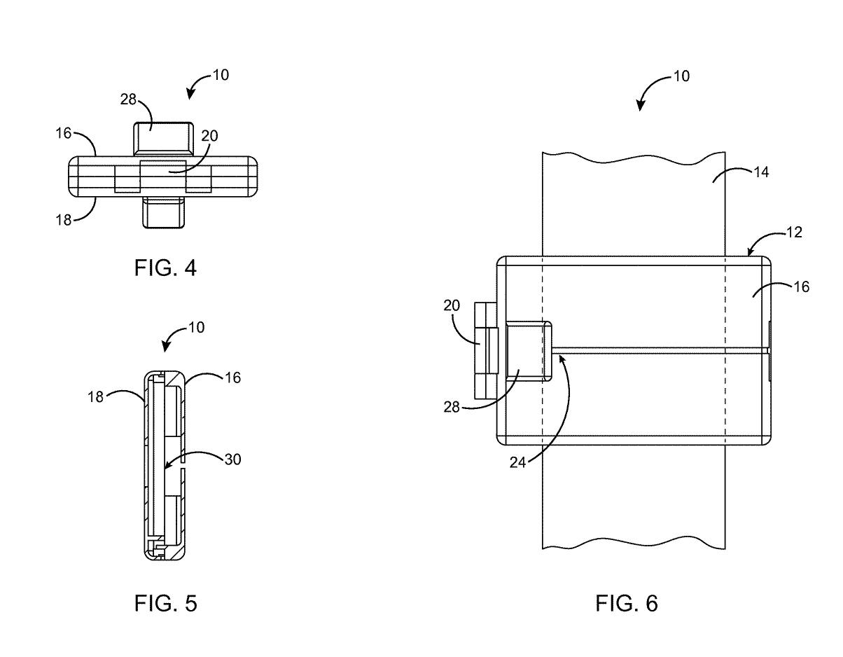

FIGS. 4 and 5 illustrate side and sectional views of the seat belt cutting device 10 in accordance with the preferred embodiment of the present invention respectively. The clip portion 12 has a cavity 30 with slotted parallel openings 32 on either side to direct the seat belt 14 there through. The movable blade 26 extends longitudinally in the cavity 30 along a surface of and across the seat belt 14 (See FIG. 6). The movable blade 26 has a protected serrated cutting edge disposed at one edge of the seat belt 14 (See FIG. 6) and inclined thereto for slitting the seat belt 14 (See FIG. 6) from side to side.

FIG. 6 illustrates the seat belt cutting device 10 attached to the seat belt 14. The seat belt cutting device 10 is configured to be mounted on the seat belt 14 of a vehicle for cutting the seat belt 14 following an accident or some other serious vehicular mishap. The seat belt cutting device 10 is portable but may be also permanently attached to the seat belt 14. The seat belt cutting device 10 could also be integrated into the design of new-production vehicles, being included with each three-point safety harness of the car or truck. The seat belt cutting device 10 can be any color to be quickly and easily seen and used when needed.

The seat belt cutting device 10 provides the motorist with a quick and easy means of escaping the interior of the vehicle if the seat belt 14 is jammed or was malfunctioning. In the event the vehicle is involved in an accident or caught in fire and the seat belt 14 is jammed, the seat belt cutting device 10 is used to free the vehicle occupant. The vehicle occupant grips the seat belt cutting device 10 and moves the movable blade 26 by means of the handle 28 which in turn cuts through the seat belt 14 strap webbing in the cavity 30 of the clip portion 12. The vehicle occupant could be quickly freed from the seat for escape or extrication by the paramedics on the scene.

The seat belt cutting device 10 provides safety, easy access, and has a user-friendly design. Instead of being unable to escape a seat following a wreck or some other emergency, the seat belt cutting device 10 could slice the seat belt 14 in half to quickly exit the interior. This could mean the difference between life and death in a fire, flood, or following a collision when immediate medical assistance is required. The seat belt cutting device 10 would also be lightweight, reliable, affordable, compact, and user-friendly.

While a particular form of the invention has been illustrated and described, it will be apparent that various modifications can be made without departing from the spirit and scope of the invention. Accordingly, it is not intended that the invention be limited, except as by the appended claims.

What is claimed is:

1. A seat belt cutting device comprising:
a clip portion having a first half portion and a second half portion, the first half portion and the second half portion attached together at a first end by means of a hinge and at a second end by means of a clip; and
a blade portion extending along the mid section of the first half portion of the clip portion, the blade portion including a movable blade and a handle attached to the blade to pull the blade;
whereby the seat belt cutting device being configured to be mounted on a seat belt of a vehicle for cutting the seat belt following an accident.

2. The seat belt cutting device of claim 1 wherein the clip portion has a cavity with slotted parallel openings on either side to direct the seat belt there through.

3. The seat belt cutting device of claim 1 wherein the clip may be released to open and close the clip portion around the seat belt for a tight fit.

4. The seat belt cutting device of claim 2 wherein the movable blade extends longitudinally in the cavity along a surface of and across the seat belt.

5. The seat belt cutting device of claim 1 wherein the movable blade has a protected serrated cutting edge disposed at one edge of the seat belt and inclined thereto for slitting the seat belt from side to side.

6. The seat belt cutting device of claim 1 is portable.

7. The seat belt cutting device of claim 1 can be any color to be quickly and easily accessible.

8. An automotive safety tool for attachment with a seat belt comprising:
a clip portion having a first half portion, a second half portion and a cavity with slotted parallel openings on either side to direct the seat belt there through, the first half portion and the second half portion attached together at a first end by means of a hinge and at a second end by means of a clip; and
a blade portion extending along the mid section of the first half portion of the clip portion, the blade portion including a movable blade and a handle attached to the blade to pull the blade;
whereby the movable blade being inclined thereto for slitting the seat belt from side to side during an emergency.

9. The automotive safety tool of claim 8 wherein the clip may be released to open and close the clip portion around the seat belt for a tight fit.

10. The automotive safety tool of claim 8 wherein the movable blade extends longitudinally in the cavity along a surface of and across the seat belt.

11. The automotive safety tool of claim 8 wherein the movable blade has a protected serrated cutting edge disposed at one edge of the seat belt.

12. The automotive safety tool of claim 8 is portable.

13. The automotive safety tool of claim 8 is brightly-colored to be quickly and easily accessible.
